(19) United States
(12) Patent Application Publication
(10) Pub. No.: US 2023/0308172 A1
(43) Pub. Date: Sep. 28, 2023

(54) APPARATUS AND METHOD OF WIRELESS COMMUNICATION

(71) Applicant: OROPE FRANCE SARL, Neuilly-sur-Seine (FR)

(72) Inventor: Hao LIN, Neuilly-sur-Seine (FR)

(21) Appl. No.: 18/202,486

(22) Filed: May 26, 2023

Related U.S. Application Data
(63) Continuation of application No. PCT/IB2021/061008, filed on Nov. 26, 2021.

(30) Foreign Application Priority Data
Nov. 26, 2020 (WO) PCT/IB2020/001006
Jan. 18, 2021 (WO) PCT/IB2021/000078

(51) Int. Cl. H04B 7/185; H04B 7/01

(52) U.S. Cl. CPC H04B 7/1855; H04B 7/01

(57) ABSTRACT

Methods of wireless communication are provided. The method performed by a user equipment (UE) includes: the UE obtaining a first information and/or a second information from a base station, and using, the first information and/or the second information for a downlink reception and/or an uplink transmission. The method performed by a base station includes: the base station indicating first information and/or a second information to UE; and configuring the UE to use the first information and/or the second information for a downlink reception and/or an uplink transmission.

### CROSS-REFERENCE TO RELATED APPLICATIONS

This application is a continuation of International Patent Application No. PCT/IB2021/061008 filed on Nov. 26, 2021, which claims the benefit of priorities to International Patent Application No. PCT/IB2020/001006 filed on Nov. 26, 2020, and International Patent Application No. PCT/IB2021/000078 filed on Jan. 18, 2021, all of which are hereby incorporated by reference in their entireties.

### BACKGROUND

Non-terrestrial networks (NTNs) refer to networks, or segments of networks, using a spaceborne vehicle or an airborne vehicle for transmission. Spaceborne vehicles include satellites including low earth orbiting (LEO) satellites, medium earth orbiting (MEO) satellites, geostationary earth orbiting (GEO) satellites, and highly elliptical orbiting (HEO) satellites. Airborne vehicles include high altitude platforms (HAPs) encompassing unmanned aircraft systems (UAS) including lighter than air (LTA) unmanned aerial systems (UAS) and heavier than air (HTA) UAS, all operating in altitudes typically between 8 and 50 km, quasi-stationary.

Communication via a satellite is an interesting means thanks to its well-known coverage, which can bring the coverage to locations that normally cellular operators are not willing to deploy either due to non-stable crowd potential client, e.g. extremely rural, or due to high deployment cost, e.g. middle of ocean or mountain peak. Nowadays, the satellite communication is a separate technology to a 3rd generation partnership project (3GPP) cellular technology. Coming to 5G era, these two technologies can merge together, i.e. we can imagine having a 5G terminal that can access to a cellular network and a satellite network. The NTN can be good candidate technology for this purpose. It is to be designed based on 3GPP new radio (NR) with necessary enhancement.

In NTN, different satellite deployment scenarios can be used. When LEO satellite is deployed, satellite velocity can augment up to more than 7 km/s, which is greatly beyond a maximum mobility speed experienced in a terrestrial network, e.g. high-speed train has a maximum speed of 500 km/h. For this reason, a transmitter as well as a receiver will face a much wider range of frequency offset and/or Doppler offset (shift). This frequency offset and/or Doppler offset (shift), due to high velocity of satellite motion, will become a severe issue to be addressed in the NTN network. However, in legacy terrestrial, there is no specified work on the frequency offset and/or Doppler offset (shift) mitigation.

Therefore, there is a need for an apparatus (such as a user equipment (UE) and/or a base station) and a method of wireless communication, which can solve issues in the prior art, provide synchronization for reception and/or transmission, reduce signaling overhead, provide a good communication performance, and/or provide high reliability.

### SUMMARY

The present disclosure relates to the field of communication systems, and more particularly, to an apparatus and a method of wireless communication, which can provide a good communication performance and/or high reliability.

An object of the present disclosure is to propose an apparatus (such as a user equipment (UE) and/or a base station) and a method of wireless communication, which can solve issues in the prior art, provide synchronization for reception and/or transmission, reduce signaling overhead, provide a good communication performance, and/or provide high reliability.

In a first aspect of the present disclosure, a method of wireless communication by a user equipment (UE) comprises obtaining, by the UE from a base station, a first information and/or a second information, and using, by the UE, the first information and/or the second information for a downlink reception and/or an uplink transmission.

In a second aspect of the present disclosure, a method of wireless communication by a base station comprises indicating, by the base station to a user equipment (UE), a first information and/or a second information, and by the base station, configuring the UE to use the first information and/or the second information for a downlink reception and/or an uplink transmission.

In a third aspect of the present disclosure, a user equipment comprises a memory, a transceiver, and a processor coupled to the memory and the transceiver. The processor is configured to obtain from a base station, a first information and/or a second information, and the processor is configured to use the first information and/or the second information for a downlink reception and/or an uplink transmission.

In a fourth aspect of the present disclosure, a base station comprises a memory, a transceiver, and a processor coupled to the memory and the transceiver. The processor is configured to indicate to a user equipment (UE), a first information and/or a second information, and the processor is configured to configure the UE to use the first information and/or the second information for a downlink reception and/or an uplink transmission.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1A is a block diagram of one or more user equipments (UEs) and a base station (e.g., gNB or eNB) of communication in a communication network system (e.g., non-terrestrial network (NTN) or a terrestrial network) according to an embodiment of the present disclosure.

FIG. 1B is a block diagram of one or more user equipments (UEs) and a base station (e.g., gNB or eNB) of communication in a non-terrestrial network (NTN) system according to an embodiment of the present disclosure.

FIG. 2 is a flowchart illustrating a method of wireless communication performed by a user equipment (UE) according to an embodiment of the present disclosure.

FIG. 3 is a flowchart illustrating a method of wireless communication performed by a base station according to an embodiment of the present disclosure.

FIG. 4 is a schematic diagram illustrating a communication system including a base station (BS) and a UE according to an embodiment of the present disclosure.

FIG. 5 is a schematic diagram illustrating that a BS transmits 3 beams to the ground forming 3 footprints according to an embodiment of the present disclosure.

FIG. 6 is a schematic diagram illustrating an uplink-downlink timing relation according to an embodiment of the present disclosure.

FIG. 7 is a schematic diagram illustrating a frequency synchronization example according to an embodiment of the present disclosure.

FIG. 8 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

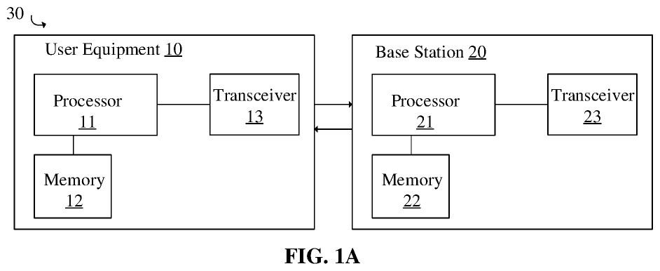

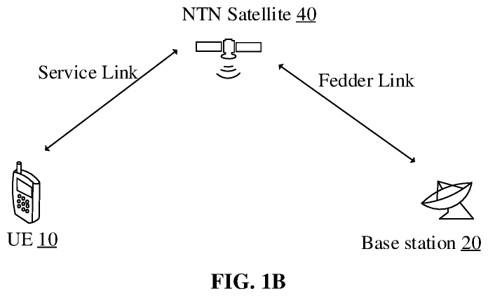

FIG. 1A illustrates that, in some embodiments, one or more user equipments (UEs) 10 and a base station (e.g., gNB or eNB) 20 for transmission adjustment in a communication network system 30 (e.g., non-terrestrial network (NTN) or terrestrial network) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the communication between the UE 10 and the BS 20 comprises non-terrestrial network (NTN) communication. In some embodiments, the base station 20 comprises spaceborne platform or airborne platform or high altitude platform station. The base station 20 can communicate with the UE 10 via a spaceborne platform or airborne platform, e.g. NTN satellite 40, as illustrated in FIG. 1B.

FIG. 1B illustrates a system which includes a base station 20 and one or more UEs 10. Optionally, the system may include more than one base station 20, and each of the base stations 20 may connect to one or more UEs 10. In this disclosure, there is no limit. As an example, the base station 20 as illustrated in FIG. 1B may be a moving base station, e.g. spaceborne vehicle (satellite) or airborne vehicle (drone). The UE 10 can transmit transmissions to the base station 20 and the UE 10 can also receive the transmission from the base station 20. Optionally, not shown in FIG. 1B, the moving base station can also serve as a relay which relays the received transmission from the UE 10 to a ground base station or vice versa. Optionally, a satellite 40 may be seen as a relay point which relays the communications between a UE 10 and a base station 20, e.g. gNB/eNB. Spaceborne platform includes satellite 40 and the satellite 40 includes LEO satellite, MEO satellite, and GEO satellite. While the satellite 40 is moving, the LEO satellite and MEO satellite are moving with regard to a given location on earth. However, for GEO satellite, the GEO satellite is relatively static with regard to a given location on earth. In some embodiments of this disclosure, some embodiments focus on the LEO satellite type or MEO satellite type, for which some embodiments of the disclosure aim at resolving an issue of wider range of frequency offset and/or Doppler offset (shift).

Spaceborne platform includes satellite and the satellite includes low earth orbiting (LEO) satellite, medium earth orbiting (MEO) satellite and geostationary earth orbiting (GEO) satellite. While the satellite is moving, the LEO and MEO satellite is moving with regard to a given location on earth. However, for GEO satellite, the GEO satellite is relatively static with regard to a given location on earth.

In some embodiments, the processor 11 is configured to obtain from the base station 20, a first information and/or a second information, and the processor 11 is configured to use the first information and/or the second information for a downlink reception and/or an uplink transmission. This can solve issues in the prior art, provide synchronization for reception and/or transmission, reduce signaling overhead, provide a good communication performance, and/or provide high reliability.

In some embodiments, the processor 21 is configured to indicate to the UE 10, a first information and/or a second information, and the processor 21 is configured to configure the UE 10 to use the first information and/or the second information for a downlink reception and/or an uplink transmission. This can solve issues in the prior art, provide synchronization for reception and/or transmission, reduce signaling overhead, provide a good communication performance, and/or provide high reliability.

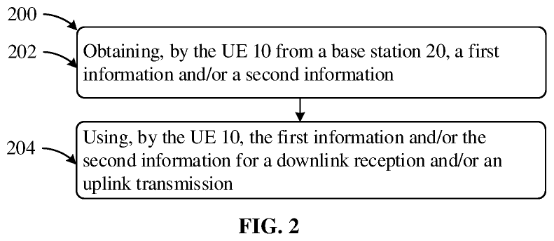

FIG. 2 illustrates a method 200 of wireless communication by a user equipment (UE) 10 according to an embodiment of the present disclosure. In some embodiments, the method 200 includes: a block 202, obtaining, by the UE 10 from a base station 20, a first information and/or a second information, and a block 204, using, by the UE 10, the first information and/or the second information for a downlink reception and/or an uplink transmission. This can solve issues in the prior art, provide synchronization for reception and/or transmission, reduce signaling overhead, provide a good communication performance, and/or provide high reliability.

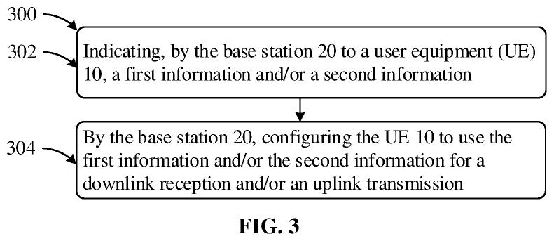

FIG. 3 illustrates a method 300 of wireless communication by a base station 20 according to an embodiment of the present disclosure. In some embodiments, the method 300 includes: a block 302, indicating, by the base station 20 to a user equipment (UE) 10, a first information and/or a second information, and a block 304, by the base station 20, configuring the UE 10 to use the first information and/or the second information for a downlink reception and/or an uplink transmission. This can solve issues in the prior art, provide synchronization for reception and/or transmission, reduce signaling overhead, provide a good communication performance, and/or provide high reliability.

In some embodiments, the first information and/or the second information is relevant to a frequency domain synchronization. In some embodiments, the frequency domain synchronization comprises at least one of the followings: one or more frequency offsets; or one or more Doppler offsets. In some embodiments, the frequency offset and/or the Doppler offset is at least on one of the followings: a service link; or a feeder link. In some embodiments, the frequency offset and/or the Doppler offset is amount of offset experienced on the service link and/or on the feeder link. In some embodiments, the frequency offset and/or Doppler offset is amount of offset compensated by the base station 20 on the service link and/or one the feeder link. In some embodiments, the frequency offset and/or the Doppler offset on the service link comprises a frequency shift on a link between a satellite 40 and the UE 10, and the link between the satellite 40 and the UE 10 comprises a link from the satellite 40 to the UE 10 and/or a link from the UE 10 to the satellite 40. In some embodiments, the frequency offset and/or the Doppler offset on the feeder link comprises a frequency shift on a link between a satellite 40 and the base station 20, and the link between the satellite 40 and the base station 20 comprises a link from the satellite to the base station 20 and/or a link from the base station 20 to the satellite 40. In some embodiments, the second information is relevant to a satellite ephemeris data and/or a reference point status. In some embodiments, the satellite ephemeris data comprises at least one of the followings: one or more satellite positions; one or more satellite velocity; one or more reference times corresponding to the one or more satellites positions and/or the one or more satellite velocity.

In some embodiments, the reference point status comprises at least one of the followings: one or more reference point positions; one or more reference point velocity; one or more reference times corresponding to the one or more reference point positions and/or the one or more reference point velocity. In some embodiments, the satellite position and/or the satellite velocity and/or the reference point position and/or the reference point velocity comprises at least one of the following forms: two dimensional coordinates; or three dimensional coordinates. In some embodiments, the three dimensional coordinates comprises three coordinate axes, and the satellite position and/or the satellite velocity and/or the reference point position and/or the reference point velocity is expressed with respect to the three coordinate axes. In some embodiments, the two dimensional coordinates comprises two coordinate axes, and the satellite position and/or the satellite velocity and/or the reference point position and/or the reference point velocity is expressed with respect to the two coordinate axes. In some embodiments, the first information and/or the second information are transmitted in at least one of the followings: a system information block (SIB); a radio resource control (RRC) message; a medium access control (MAC) control element (CE); or a downlink control information (DCI). In some embodiments, the SIB comprises SIB x, wherein x is an integer larger than or equal to 1. In some embodiments, the RRC message comprises at least one of the followings: a cell-specific RRC message; or a UE-specific RRC message. In some embodiments, the RRC message comprises an RRC information element (IE) for an intra-frequency measurement and/or an inter-frequency measurement. In some embodiments, the intra-frequency measurement and/or the inter-frequency measurement is based on a synchronization signal block (SSB) and/or a channel state information-reference signal (CSI-RS). In some embodiments, the RRC IE comprises MeasObjectNR.

In some embodiments, the first information and/or the second information are associated with one or more cell indexes and/or one or more beam indexes and/or one or more frequencies. In some embodiments, the one or more frequencies comprise at least one of the followings: SSB frequency; or reference frequency for the CSI-RS. In some embodiments, the one or more frequencies comprise a first point, point A, which is used for mapping of the CSI-RS to physical resources according to TS 38.211 clause 7.4.1.5.3. In some embodiments, the SSB frequency is associated with the MeasObjectNR.

In some embodiments, the one or more beam indexes comprises at least one of the followings: an SSB index; a CSI-RS resource index; or a CSI-RS resource set index. In some embodiments, the one or more beam indexes are configured in the MeasObjectNR. In some embodiments, the one or more cell indexes are configured in the MeasObjectNR. In some embodiments, the method of the UE 10 using the first information and/or the second information for the downlink reception and/or the uplink transmission comprises: the UE 10 compensating a first frequency offset or a first Doppler offset for the downlink reception and/or the UE 10 compensating the first frequency offset or the first Doppler offset for the uplink transmission. In some embodiments, the first frequency offset is derived from at least one of the followings: a second frequency offset; or a third frequency offset. In some embodiments, the second frequency offset is obtained from the first information. In some embodiments, the third frequency offset is derived from the second information. In some embodiments, the third frequency offset is derived by the UE 10 from the satellite ephemeris data and/or the reference point status. In some embodiments, the third frequency offset is obtained from the first information.

In some embodiments, the first frequency offset is derived from at least one of the followings: a subtraction of the second frequency offset and the third frequency offset; or an addition of the second frequency offset and the third frequency offset. In some embodiments, the first Doppler offset is derived from at least one of the followings: a second Doppler offset; or a third Doppler offset. In some embodiments, the second Doppler offset is obtained from the first information. In some embodiments, the third Doppler offset is derived from the second information. In some embodiments, the third Doppler offset is derived by the UE 10 from the satellite ephemeris data and/or the reference point status. In some embodiments, the third Doppler offset is obtained from the first information. In some embodiments, the first Doppler offset is derived from at least one of the followings: a subtraction of the second Doppler offset and the third Doppler offset; or an addition of the second Doppler offset and the third Doppler offset. In some embodiments, the UE 10 determines the subtraction or the addition of the second frequency offset and the third frequency offset based on the downlink reception or the uplink transmission. In some embodiments, the first frequency offset comprises the second frequency offset and the third frequency offset. In some embodiments, the first frequency offset comprises a difference between the second frequency offset and the third frequency offset. In some embodiments, the UE 10 determines the subtraction or the addition of the second Doppler offset and the third Doppler offset based on the downlink reception or the uplink transmission. In some embodiments, the first Doppler offset comprises the second Doppler offset and the third Doppler offset. In some embodiments, the first Doppler offset comprises a difference between the second Doppler offset and the third Doppler offset.

In some examples, the UE 10 may obtain the second frequency offset from the first information and derives a third frequency offset from the satellite ephemeris data and the reference point status in the second information. The third frequency offset may be a true frequency offset on the service link and the second frequency offset may be the base station 20 compensated frequency offset on the service link. For downlink reception, the UE 10 may compensate a first frequency offset on the downlink transmission, where the first frequency offset is a difference between the true frequency offset and the base station compensated frequency offset, i.e. the first frequency offset is a subtraction of the second frequency offset and the third frequency offset. Optionally, the second frequency offset may be a frequency offset on the feeder link from the satellite 40 to the base station 20 and the third frequency offset is a true frequency offset on the service link from the UE 10 to the satellite 40. When the UE 10 transmits an uplink transmission, the UE 10 compensates the first frequency offset for the uplink transmission, where the first frequency offset includes both the second frequency offset and the third frequency offset, i.e. the first frequency offset is an addition of the second frequency offset and the third frequency offset.

In some embodiments, the frequency offset and/or the Doppler offset comprises N times Fs, where Fs is a frequency granularity in Hertz and N is an integer. In some embodiments, N comprises a positive sign and/or a negative sign. In some embodiments, the frequency offset or the Doppler offset is zero at a reference point.

In some embodiments, the downlink reception comprises at least one of the followings: a physical downlink sharing channel (PDSCH) reception; a physical downlink control channel (PDCCH) reception, an SSB reception; or a CSI-RS reception. In some embodiments, the uplink transmission comprises at least one of the followings: a physical uplink shared channel (PUSCH) transmission; a physical uplink control channel (PUCCH) transmission; a physical random access channel (PRACH) transmission; or a sounding reference signal (SRS) transmission.

In some embodiments, the UE is configured to compensate the third frequency offset or the third Doppler offset for the uplink transmission with respect to a first reference point. In some embodiments, UE is configured to compensate the third frequency offset or the third Doppler offset and/or a common offset for the uplink transmission with respect to the first reference point. In some embodiments, the common offset is indicated by the base station to the UE. In some embodiments, the common offset is indicated in at least one of the followings: a system information, an RRC message, a MAC-CE, or a DCI. In some embodiments, the common offset comprises at least one of the followings: comFd_sl_ul as a common frequency offset on the service link for uplink; or Fd_f1_ul as a frequency offset on the feeder link for uplink. In some embodiments, the third frequency offset or the third Doppler offset comprises a UE-specific Doppler shift on the service link for the uplink transmission. In some embodiments, the first reference point comprises an uplink nominal frequency of the base station. In some embodiments, the first reference point is equal to a second reference point plus or minus a duplex offset.

In some embodiments, the second reference point comprises a downlink nominal frequency of the base station. In some embodiments, the duplex offset is pre-configured or pre-defined. In some embodiments, the UE is configured to compensate the third frequency offset or the third Doppler offset for the uplink transmission. In some embodiments, the third frequency offset or the third Doppler offset comprises a UE-specific Doppler shift on an uplink service link for the uplink transmission. In some embodiments, the UE-specific Doppler shift on the uplink service link is determined at least from one of the followings: the satellite ephemeris data; the UE position; or the UE-specific Doppler shift on a downlink service link. In some embodiments, the UE is configured to determine the downlink nominal frequency of the base station (gNB_f_dl) according to at least one of the followings: Rx_f, f3, f2_dl, or f1, where Rx_f is a downlink nominal frequency or a reference downlink receive frequency of the UE, f3 is a residual frequency shift, f2_dl is the third frequency offset or the third Doppler offset on the downlink service link, and f1 is a common frequency pre-compensation. In some embodiments, gNB_f_dl=Rx_f+f3−f2_dl+f1; or gNB_f_dl=Rx_f-f3−f2_dl+f1.

In some embodiments, f3 is the residual frequency shift comprising a frequency shift between a frequency at which downlink signal arrives at the UE and the Rx_f. In some embodiments, f2_dl is the third frequency offset or the third Doppler offset on the downlink service link for the downlink reception comprising a UE-specific Doppler shift on the downlink service link for the downlink reception. In some embodiments, the UE-specific Doppler shift on the downlink service link for the downlink reception is determined from the satellite ephemeris data and/or the UE position. In some embodiments, f1 is indicated by the base station and/or f1 is performed by the base station. In some embodiments, f1 comprises at least one of the followings: comFd_sl_dl as a common frequency offset on the service link for downlink; or Fd_f1_dl as a frequency offset on the feeder link for downlink. In some embodiments, Rx_f plus f3 or Rx_f minus f3 is determined from a downlink reference signal. In some embodiments, a value of f1 is provided by the base station to the UE. In some embodiments, a value of the common offset is provided by the base station to the UE. In some embodiments, the value of f1 comprises zero.

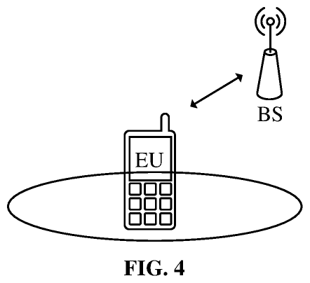

FIG. 4 illustrates a communication system including a base station (BS) and a UE according to another embodiment of the present disclosure. Optionally, the communication system may include more than one base station, and each of the base stations may connect to one or more UEs. In this disclosure, there is no limit. As an example, the base station illustrated in FIG. 1A may be a moving base station, e.g. spaceborne vehicle (satellite) or airborne vehicle (drone). The UE can transmit transmissions to the base station and the UE can also receive the transmission from the base station. Optionally, not shown in FIG. 4, the moving base station can also serve as a relay which relays the received transmission from the UE to a ground base station or vice versa.

Spaceborne platform includes satellite and the satellite includes LEO satellite, MEO satellite and GEO satellite. While the satellite is moving, the LEO and MEO satellite is moving with regards to a given location on earth. However, for GEO satellite, the GEO satellite is relatively static with regards to a given location on earth. A moving base station or satellite, e.g. in particular for LEO satellite or drone, communicates with a user equipment (UE) on the ground. Due to long distance between the UE and the base station on satellite, the beamformed transmission is needed to extend the coverage.

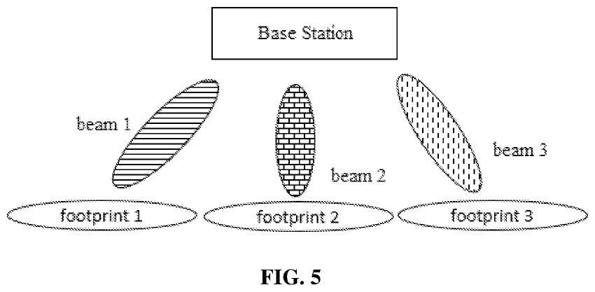

Optionally, as illustrated in FIG. 5, where a base station is integrated in a satellite or a drone, and the base station transmits one or more beams to the ground forming one or more coverage areas called footprint. In FIG. 5, an example illustrates that the BS transmits three beams (beam 1, beam 2 and beam 3) to form three footprints (footprint 1, 2 and 3), respectively. Optionally, 3 beams are transmitted at 3 different frequencies. In this example, the bit position is associated with a beam. FIG. 5 illustrates that, in some embodiments, a moving base station, e.g. in particular for LEO satellite or drone, communicates with a user equipment (UE) on the ground. Due to long distance between the UE and the base station on satellite, the beamformed transmission is needed to extend the coverage. As illustrated in FIG. 5, where a base station is transmitting three beams to the earth forming three coverage areas called footpoints. Moreover, each beam may be transmitted at dedicated frequencies so that the beams for footprint 1, 2 and 3 are non-overlapped in a frequency domain. The advantage of having different frequencies corresponding to different beams is that the inter-beam interference can be minimized.

In some embodiments, a moving base station (BS), e.g. in particular for LEO satellite or drone, communicates with a user equipment (UE) on the ground. A round trip time (RTT) between the BS and the UE is time varying. The RTT variation is related to a distance variation between the BS and the UE. The RTT variation rate is proportional to a BS motion velocity. To ensure a good uplink synchronization, the BS will adjust an uplink transmission timing and/or frequency for the UE. In some embodiments of this disclosure, a method for uplink synchronization adjustment is provided, and the uplink synchronization adjustment comprises at least one of the followings: a transmission timing adjustment or a transmission frequency adjustment. Optionally, the transmission timing adjustment further comprises a timing advance (TA) adjustment.

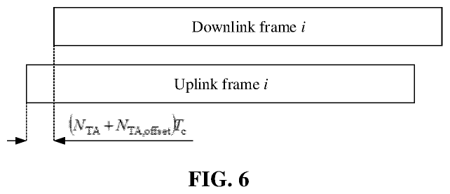

FIG. 6 illustrates an uplink-downlink timing relation according to an embodiment of the present disclosure. FIG. 6 illustrates that, in some embodiments, downlink, and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. T_{f} refers to a radio frame duration. Δ_{f} refers to subcarrier spacing. N_{f} refers to a system frame number (SFN). T_{c} refers to a basic time unit for NR. T_{sf} refers to a subframe duration. The number of consecutive orthogonal frequency division multiplexed (OFDM) symbols per subframe is N refers to N_{symb}^{subframe,μ}=N_{symb}^{slot}Nₛₗₒₜ^{subframe,μ}. N_{symb}^{subframe,μ} number of OFDM symbols per subframe for subcarrier spacing configuration μ. N_{symb}^{slot} refers to number of symbols per slot. Nₛₗₒₜ^{subframe,μ} refers to number of slots per subframe for subcarrier spacing configuration μ. Each frame is divided into two equally-sized half-frames of five subframes each with half-frame 0 consisting of subframes 0 to 4 and half-frame 1 consisting of subframes 5 to 9. There is one set of frames in the uplink and one set of frames in the downlink on a carrier. Uplink frame number i for transmission from the UE starts T_{TA}=(N_{TA}+N_{TA,offset})T_{c} before the start of the corresponding downlink frame at the UE where N_{TA,offset} is given by TS 38.213, except for a message A (msgA) transmission on physical uplink shared channel (PUSCH) where T_{TA}=0 is used. T_{TA} refers to timing advance between downlink and uplink. N_{TA} refers to timing advance between downlink and uplink. N_{TA,offset} refers to a fixed offset used to calculate the timing advance. T_{c} refers to a basic time unit for NR.

Some embodiments of the disclosure cover two cases: earth moving beam and earth fixed beam. The earth moving beam means that the transmission beam sent by the satellite is a fixed beam and cannot be adjusted. In this case, when the satellite moves, the transmission beam is also moving. On the other hand, the earth fixed beam means that when the satellite moves, the satellite will adjust the transmission beam in order to ensure its projection or coverage on the earth is not changed.

Feeder link (FL) is between a satellite and a base station. A feeder link for uplink (f1_ul) refers to a transmission link from the satellite to the base station, and a feeder link for downlink (f1_dl) refers to a transmission link from the base station to the satellite. Service link (SL) is between the satellite and a UE. A service link for uplink (sl_ul) refers to a transmission link from the UE to the satellite. A service link for downlink (sl_dl) refers to a transmission link from the satellite to the UE. In some examples, f1_ul, f1_dl, sl_ul, and sl_dl may be at different frequencies. In some examples, sl_ul and sl_dl may be at a same frequency. In some examples, f1_ul and f1_dl may be at a same frequency.

In some embodiments of this disclosure, we denote: resFd_sl_dl as a residual frequency offset on the service link for downlink; resFd_sl_ul as a residual frequency offset on the service link for uplink; Fd_sl_dl as a frequency offset on the service link for downlink; Fd_sl_ul as a frequency offset on the service link for uplink; comFd_sl_dl as a common frequency offset compensated by the base station on the service link for downlink; comFd_sl_ul as a common frequency offset compensated by the base station on the service link for uplink; Fd_f1_dl as a frequency offset on the feeder link for downlink; and Fd_f1_ul as a frequency offset on the feeder link for uplink.

In some examples, as illustrated in FIG. 1B, when a base station 20 transmits a downlink transmission to a UE 10 in NTN system, the transmission may go through a feeder link between the base station 20 (a gateway) and a satellite 40, and the transmission may further go through a service link between the satellite 40 and the UE 10. Due to the mobility of the satellite 40, frequency offset and/or Doppler offset (shift) may be introduced in the feeder link and the service link. The base station 20 may pre-compensate a part of the frequency offset and/or the Doppler offset on the feeder link and/or on the service link. With this pre-compensation, the UE 10 may experience less frequency offset and/or Doppler offset range and this will ease the UE 10 to detect synchronization signal, e.g. primary synchronization sequence (PSS). In some embodiments, the frequency offset and/or the Doppler offset (shift) on the service link comprises a frequency shift on a link between the satellite 40 and the UE 10, and the link between the satellite 40 and the UE 10 comprises a downlink and/or an uplink. In some embodiments, the frequency offset and/or the Doppler offset (shift) on the feeder link comprises a frequency shift on a link between a satellite 40 and the base station 20, and the link between the satellite 40 and the base station 20 comprises a link from the satellite to the base station 20 and/or a link from the base station 20 to the satellite 40. In some embodiments, the downlink reception comprises at least one of the followings: a physical downlink sharing channel (PDSCH) reception; a physical downlink control channel (PDCCH) reception, an SSB reception; or a CSI-RS reception.

Since the base station 20 does not know exact position of the UE 10, the base station 20 may only pre-compensate part of the frequency offset and/or Doppler offset (shift) on the service link. In this case, there are still some residual frequency offset and/or Doppler offset (shift) on the service link. To mitigate the residual frequency offset and/or Doppler offset (shift), the UE 10 may estimate or calculate the residual frequency offset and/or Doppler offset (shift) based on downlink reference signals, e.g. SSB or CSI-RS. Optionally, the UE may estimate or calculate the residual frequency offset and/or Doppler offset (shift) by resFd_sl_dl=Fd_sl_dl−comFd_sl_dl, where resFd_sl_dl is a residual frequency offset and/or Doppler offset (shift) or a residual frequency offset and/or Doppler offset (shift) on service link; Fd_sl_dl is a true frequency offset and/or Doppler offset (shift) on the service link; comFd_sl_dl is a pre-compensated frequency offset and/or Doppler offset (shift) by the network on the service link. The true frequency offset and/or Doppler offset (shift) on the service link (Fd_sl_dl) can be obtained by the UE 10 based on the UE position and velocity and satellite position and velocity. In this case the base station 20 may need to inform the UE 10 about the satellite ephemeris data.

Ephemeris data contains information about orbital trajectories of artificial satellites. There are different possible representations of ephemeris data. One possibility is to use orbital parameters, e.g. semi-major axis, eccentricity, inclination, right ascension of the ascending node, argument of periapsis, mean anomaly at a reference point in time, and the epoch. The first five parameters can determine an orbital plane, and the other two parameters are used to determine exact satellite location at a time. Another possible option is to provide the location of the satellite in coordinates (x, y, z), e.g. ECEF coordinates. For anything else than GEO, additionally a velocity vector (vx, vy, vz) and again a reference point in time are needed. A description table 1 for the orbital parameters and the corresponding illustrations are as below.

TABLE 1
Essential Elements of Ephemeris

| | | |
|---|---|---|
| Orbital plane | \sqrt{a} | Square root of semi major axis (semi-major axis) |
| parameters | e | Eccentricity (eccentricity) |
| | i₀ | Inclination angle at reference time (inclination) |
| | Ω₀ | Longitude of ascending node of orbit plane (right |
| | | ascension of the ascending node) |
| | ω | Argument of perigee (argument of periapsis) |
| Satellite | M₀ | Mean anomaly at reference time (true anomaly and |
| level | | a reference point in time) |
| parameters | t₀ₑ | Ephemeris reference time (the epoch) |

Ephemeris is expressed in an ASCII file using Two-Line Element (TLE) format. The TLE data format encodes a list of orbital elements of an Earth-orbiting object in two 70-column lines. The contents of the TLE table are reproduced below. The reference time comprises a global positioning system (GPS) time or a coordinated universal time (UTC) time.

TABLE 2
First line of the ephemeris

| Field | Columns | Content |
|---|---|---|
| 1 | 01-01 | Line number (1) |
| 2 | 03-07 | Satellite number |
| 3 | 08-08 | Classification (U = Unclassified) |
| 4 | 10-11 | International Designator (Last two digits of launch year) |
| 5 | 12-14 | International Designator (Launch number of the year) |
| 6 | 15-17 | International Designator (piece of the launch) |
| 7 | 19-20 | Epoch Year (last two digits of year) |
| 8 | 21-32 | Epoch (day of the year and fractional portion of the day) |
| 9 | 34-43 | First Time Derivative of the Mean Motion divided by two |
| 10 | 45-52 | Second Time Derivative of Mean Motion divided by six (decimal point assumed) |
| 11 | 54-61 | BSTAR drag term (decimal point assumed) |
| 12 | 63-63 | The number 0 (originally this should have been “Ephemeris type”) |
| 13 | 65-68 | Element set number. Incremented when a new TLE is generated for this object. |
| 14 | 69-69 | Checksum (modulo 10) |

TABLE 3
Second line of the ephemeris

| Field | Columns | Content |
|---|---|---|
| 1 | 01-01 | Line number (2) |
| 2 | 03-07 | Satellite number |
| 3 | 09-16 | Inclination (degrees) |
| 4 | 18-25 | Right ascension of the ascending node (degrees) |
| 5 | 27-33 | Eccentricity (decimal point assumed) |
| 6 | 35-42 | Argument of perigee (degrees) |
| 7 | 44-51 | Mean Anomaly (degrees) |
| 8 | 53-63 | Mean Motion (revolutions per day) |
| 9 | 64-68 | Revolution number at epoch (revolutions) |
| 10 | 69-69 | Checksum (modulo 10) |

After obtaining the satellite ephemeris data, the UE 10 can calculate the Fd_sl_dl using the satellite ephemeris data and the UE position. In some examples, the base station 20 may also inform the UE 10 about the comFd_sl_dl, so that the UE 10 can derive the residual frequency offset and/or Doppler offset (shift) resFd_sl_dl by removing the comFd_sl_dl part from the Fd_sl_dl. Optionally, the base station 20 informs the UE 10 about the comFd_sl_dl, and the base station 20 leaves the UE 10 to decide whether or not to use the comFd_sl_dl to derive the resFd_sl_dl.

In some examples, the base station 20 may directly signal the comFd_sl_dl to the UE 10. Optionally, the base station 20 may signal a reference point position and the UE 10 can derive the comFd_sl_dl based on the satellite position and the reference point position. Note that the reference point is a point where the frequency offset and/or Doppler offset (shift) is zero, i.e. completely pre-compensated by the base station 20. The advantage of signaling reference point position is that the UE 10 can directly adjust the comFd_sl_dl value, in case the comFd_sl_dl is changing over time, without the need of updating the signaling, leading to a reduced signaling overhead. In some examples, the comFd_sl_dl or the reference point position may be signaled in at least one of the followings: a system information including SIBx, where x is an integer; cell specific RRC; UE-specific RRC; MAC-CE; or DCI. In some examples, when the base station 20 signals comFd_sl_dl, it may be in a unit of Hz. Optionally, the base station 20 may signal a value of N, and the UE 10 derives comFd_sl_dl by comFd_sl_dl=N*Fs, where N is the signaled value and Fs is a frequency granularity in Hz. Optionally, the value of N is an integer.

In some examples, the base station 20 configures the UE 10 to perform measurement on a serving cell or one or more neighbor cells in MeasObjectNR (MO) IE. In this IE, the base station 20 configures a frequency point at which the UE 10 performs the measurement on SSB. Moreover, in the MO IE, the base station 20 may further configure one or more target cells for the UE 10 to measure. The IE MeasObjectNR specifies information applicable for SS/PBCH block(s) intra/inter-frequency measurements and/or CSI-RS intra/inter-frequency measurements. MeasObjectNR information element and MeasObjectNR field descriptions may refer to TS 38.331. In some embodiments of the disclosure, when the UE 10 detects an SSB it can derive the associated cell index and further check if the associated cell index belongs to the configured one or more target cells. Furthermore, in the MO IE, the base station 20 may provide an information which is at least one of the followings: a satellite ephemeris data corresponding to the one or more configured target cells; information relevant to a reference point position corresponding to the one or more configured target cells; or information relevant to a comFd_sl_dl corresponding to the one or more configured target cells. Optionally, the information may be further relevant to beam index, e.g. SSB index and/or CSI-RS resource index. For instance, when the information is relevant to a reference point position, the base station 20 may provide a set of reference point (RP) positions, which are associated with a set of SSB indexes, e.g. RP0 for SSB index 0, RP1 for SSB index 1, etc. Optionally, the satellite ephemeris data and/or information about comFd_sl_dl may be associated to a frequency, where the frequency is associated with the MeasObjectNR, e.g. ssbFrequency or refFreqCSI-RS. In some examples, when the satellite ephemeris data and/or the information about comFd_sl_dl is associated to a frequency, the UE assumes that the satellite ephemeris data and/or the information about comFd_sl_dl is the same among a set of cell indexes and/or a set of beam indexes configured in a same MeasObjectNR.

In some examples, when the UE 10 transmits an uplink to the base station 20, the UE pre-compensates a frequency offset and/or Doppler offset (shift), e.g. the uplink transmission can be expressed as below:

s(t)=e^{-j2παt}*s₁(t) where s₁(t) is an OFDM baseband signal generated according to TS 38.211 section 5.3; and a is relevant to a frequency offset and/or Doppler offset (shift) to be pre-compensated for the uplink transmission. In some examples, the a comprises at least one of the followings: a residual frequency offset and/or Doppler offset (shift) for uplink resFd_sl_ul; a true frequency offset and/or Doppler offset (shift) on the service link for uplink Fd_sl_ul; or a true frequency offset and/or Doppler offset (shift) on the feeder link Fd_f1_ul. In some examples, resFd_sl_ul is relevant to resFd_sl_dl, or resFd_sl_ul can be derived from resFd_sl_dl. In some examples, Fd_sl_ul is relevant to Fd_sl_dl, or Fd_sl_ul can be derived from Fd_sl_dl. In some examples, the UE 10 compensates a first frequency offset for an uplink, where the first frequency offset includes a second frequency offset and a third frequency offset. The second frequency offset is a feeder link frequency offset and the third frequency offset is a service link frequency offset. The second frequency offset is indicated by the base station 20 and the third frequency offset is derived by the UE 10 from satellite ephemeris data and a reference point position. In some examples, the frequency offset on the service link for uplink refers to the frequency offset on the link from the UE 10 to the satellite 40. The frequency offset on the service link for downlink refers to the frequency offset on the link from the satellite 40 to the UE 10. In some examples, the service link for uplink is at a different frequency from the service link for downlink. In some examples, the frequency offset on the service link for uplink can be derived from the frequency offset on the service link for downlink based on their respective frequencies, e.g. Fd_sl_ul is proportional to (f_ul/f_dl)*Fd_sl_dl, where f_ul is the uplink frequency and f_dl is the downlink frequency. Optionally, similar example is applied for residual frequency offset on the service link, i.e. resFd_sl_ul and resFd_sl_dl and/or frequency offset for feeder link i.e. Fd_f1_ul and Fd_f1_dl. In some examples, the base station 20 indicates the UE 10 to perform frequency offset and/or Doppler offset (shift) pre-compensation or not. In some examples, when the base station 20 provides an information relevant to a, the UE 10 performs frequency offset and/or Doppler offset (shift) pre-compensation. In some examples, when the base station 20 does not provide the information relevant to a, the UE 10 does not perform frequency offset and/or Doppler offset (shift) pre-compensation. In some examples, the base station 20 provides the information relevant to a in at least one of the followings: a system information including SIBx, where x is an integer; cell specific RRC; UE-specific RRC; MAC-CE; or DCI. In some examples, the frequency offset and/or Doppler offset (shift) a is timing varying. In this case, the base station 20 provides a set of a, with each corresponding to a dedicated time interval. The UE 10 selects an a corresponding to a time interval in which the uplink is to be transmitted, and performs frequency offset and/or Doppler offset (shift) pre-compensation, using the selected a, for the uplink transmission. In some embodiments, the uplink transmission comprises at least one of the followings: a physical uplink shared channel (PUSCH) transmission; a physical uplink control channel (PUCCH) transmission; a physical random access channel (PRACH) transmission; or a sounding reference signal (SRS) transmission.

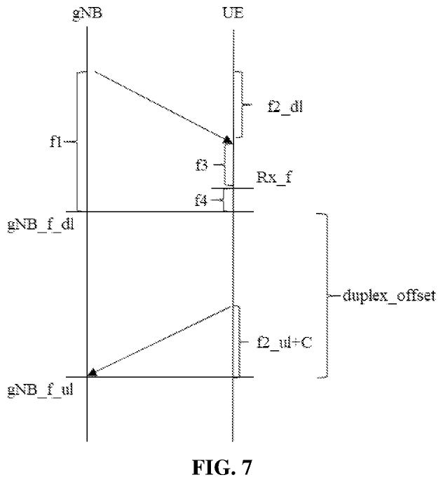

FIG. 7 illustrates a frequency synchronization example according to an embodiment of the present disclosure. In some embodiments, a connected UE, an idle UE, or an inactive UE shall be capable of supporting self-estimation on frequency shift for the service link. Thus, the frequency synchronization shall take advantage of this UE capacity. FIG. 7 illustrates that, in some embodiments, a UE receives a downlink signal from a gNB. Some embodiments assume that the gNB transmits the downlink signal at a reference frequency or a nominal frequency for downlink; while the UEs's nominal frequency for receiving the downlink signal is denoted by Rx_f. In some examples, there is a frequency error between the gNB's nominal frequency and UE's nominal frequency, which is denoted by f4 in FIG. 7. When a UE receives a downlink reference signal, the downlink reference signal will arrive at the UE side with a frequency shift due to, e.g. Doppler shift, and the UE can estimate the frequency shift between frequency at which the downlink signal arrives and the Rx_f, and the frequency shift is denoted by f3. However, if the UE directly applies f3 as a pre-compensation with respect to the Tx_f, which is a UE uplink nominal frequency and the Tx_f is a shifted frequency with respect to Rx_f by a duplex offset, the uplink frequency between different UEs cannot be synchronized, leading to a severe orthogonality issue among UEs. From this example, only pre-compensate for residual Doppler shift is not working due to large UE-specific Doppler shift on the service link. Thus, the UE has to pre-compensate for UE-specific Doppler shift on the uplink service link based on the gNB's nominal frequency for uplink transmission. For doing so, the UE needs to know gNB_f_ul frequency. The gNB's nominal frequency for uplink is obtained from the gNB's nominal frequency for downlink shifted by the duplex offset. Thus, as long as the UE obtains the gNB's nominal frequency for downlink, the UE can determine the gNB_f_ul. It is to note that the UE knows a priori the duplex offset.

For frequency synchronization, UE only pre-compensates residual frequency shift for uplink may introduce orthogonality issue with different UEs. FIG. 7 illustrates that, in some embodiments, an efficient way is that the UE shall pre-compensate UE-specific Doppler shift on the service link. But for doing so, the UE needs to know gNB downlink nominal frequency. In practice, the UE does not need to know exactly where the gNB nominal frequency is. Instead, the UE may assume that: gNB_f_dl=Rx_f+/−f3−f2_dl+f1, where Rx_f+/−f3 is denoted in our example as a receiver frequency shift and it is determined from DL reference signal (It is to note that based on the downlink reference signal or downlink synchronization signal, e.g. SSB or tracking reference signal (TRS), the UE can estimate if the downlink signal arrives at UE side at a frequency lower than the Rx_f or higher than the Rx_f. Assuming the absolute frequency shift value is f3, when the arrived frequency is lower than the Rx_f, the UE will determine the frequency shift as Rx−f3. When the arrived frequency is higher than the Rx_f, the UE will determine the frequency shift as Rx+f3. Optionally, if we assume that the f3 is not an absolute frequency shift value and it can be positive or negative or zero, when f3 is positive, it means that the arrived frequency is higher than the Rx_f. When f3 is negative, it means that the arrived frequency is lower than the Rx_f. In this case, UE determines the frequency shift as Rx_f+f3), f2_dl is the UE-specific Doppler shift on the service link, which is determined from the satellite ephemeris and/or the UE position; f1 is a common frequency pre-compensation (C) possibly performed on the gNB side, which can be indicated by the gNB. In some examples, when the gNB does not indicate f1, or the UE does not obtain the information about f1 from the gNB, the UE assumes f1=0. Once the UE determines the gNB_f_dl, the UE can perform a pre-compensation for the uplink transmission by f2_ul and/or a common offset (C) with respect to gNB_f_ul. In some examples, f2_ul is obtained by the satellite ephemeris data and/or the UE position. Optionally, the f2_ul is obtained from the f2_dl and scaled proportional to the ratio between the downlink nominal frequency and uplink nominal frequency. In some examples, the gNB_f_ul is obtained from the gNB_f_dl and the duplex offset. In some examples, the common offset (C) is provided by the gNB to the UE in at least one of the followings: a system information, a RRC message, a MAC-CE, or a DCI. Optionally, when the UE does not obtain any information about the common offset from the gNB, the UE assumes the common offset is zero. With this, the orthogonality can be maintained among UEs. In this example, a proposal, for uplink frequency synchronization, a UE shall pre-compensate the UE-specific Doppler shift on the service link with respect to a gNB's uplink nominal frequency, is provided.

Commercial interests for some embodiments are as follows. 1. Solving issues in the prior art. 2. Providing synchronization for reception and/or transmission. 3. Reducing signaling overhead. 4. Providing a good communication performance 5. Providing a high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

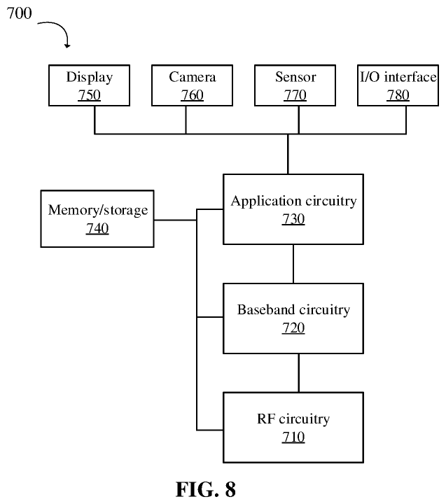

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of wireless communication for user equipment (UE), the method comprising:
obtaining, by the UE from a base station, a first information and/or a second information; and
using, by the UE, the first information and/or the second information for a downlink reception and/or an uplink transmission.

2. The method of claim 1, wherein the first information and/or the second information is relevant to a frequency domain synchronization, and the frequency domain synchronization comprises at least one of the followings: one or more frequency offsets; or one or more Doppler offsets,
wherein the frequency offset and/or the Doppler offset is at least on one of the followings: a service link; or a feeder link,
wherein the frequency offset and/or the Doppler offset is amount of offset experienced on the service link and/or on the feeder link, or
the frequency offset and/or Doppler offset is amount of offset compensated by the base station on the service link and/or on the feeder link.

3. The method of claim 1, wherein the second information is relevant to a satellite ephemeris data and/or a reference point status,
the satellite ephemeris data comprises at least one of the followings: one or more satellite positions; one or more satellite velocity; one or more reference times corresponding to the one or more satellites positions and/or the one or more satellite velocity, and
the reference point status comprises at least one of the followings: one or more reference point positions; one or more reference point velocity; one or more reference times corresponding to the one or more reference point positions and/or the one or more reference point velocity.

4. The method of claim 1, wherein the first information and/or the second information are transmitted in at least one of the followings: a system information block (SIB); a radio resource control (RRC) message; a medium access control (MAC) control element (CE); or a downlink control information (DCI),
wherein the SIB comprises SIB x, wherein x is an integer larger than or equal to 1,
the RRC message comprises at least one of the followings: a cell-specific RRC message; or a UE-specific RRC message, and the RRC message comprises an RRC information element (IE) for an intra-frequency measurement and/or an inter-frequency measurement,
wherein the intra-frequency measurement and/or the inter-frequency measurement is based on a synchronization signal block (SSB) and/or a channel state information-reference signal (CSI-RS), and the RRC IE comprises MeasObjectNR.

5. The method of claim 1, wherein using, by the UE, the first information and/or the second information for the downlink reception and/or the uplink transmission comprises:
compensating, by the UE, a first frequency offset or a first Doppler offset for the downlink reception, and/or compensating, by the UE, the first frequency offset or the first Doppler offset for the uplink transmission,
wherein the first frequency offset is derived from at least one of the followings: a second frequency offset; or a third frequency offset.

6. A method of wireless communication for a base station, the method comprising:
indicating, by the base station to user equipment (UE), a first information and/or a second information; and
configuring, by the base station, the UE to use the first information and/or the second information for a downlink reception and/or an uplink transmission.

7. The method of claim 6, wherein the first information and/or the second information is relevant to a frequency domain synchronization, and the frequency domain synchronization comprises at least one of the followings: one or more frequency offsets; or one or more Doppler offsets,
wherein the frequency offset and/or the Doppler offset is at least on one of the followings: a service link; or a feeder link, and
the frequency offset and/or the Doppler offset is amount of offset experienced on the service link and/or on the feeder link, or the frequency offset and/or Doppler offset is amount of offset compensated by the base station on the service link and/or on the feeder link.

8. The method of claim 6, wherein configuring, by the base station, the UE to use the first information and/or the second information for the downlink reception and/or the uplink transmission comprises:
configuring, by the base station, the UE to compensate a first frequency offset or a first Doppler offset for the downlink reception and/or the UE to compensate the first frequency offset or the first Doppler offset for the uplink transmission.

9. The method of claim 8, wherein the first frequency offset is derived from at least one of the followings: a second frequency offset; or a third frequency offset,
the second frequency offset is obtained from the first information, and
the third frequency offset is derived from the second information, and the third frequency offset is derived by the UE from a satellite ephemeris data and/or a reference point status; or the third frequency offset is obtained from the first information; and
wherein the first Doppler offset is derived from at least one of the followings: a second Doppler offset; or a third Doppler offset,
the second Doppler offset is obtained from the first information, and the third Doppler offset is derived from the second information, and
the third Doppler offset is derived by the UE from the satellite ephemeris data and/or the reference point status, or the third Doppler offset is obtained from the first information.

10. User equipment (UE), comprising:
a memory;
a transceiver; and
a processor coupled to the memory and the transceiver;
wherein the processor is configured to obtain from a base station, a first information and/or a second information; and
wherein the processor is configured to use the first information and/or the second information for a downlink reception and/or an uplink transmission.

11. The UE of claim 10, wherein the first information and/or the second information is relevant to a frequency domain synchronization, and the frequency domain synchronization comprises at least one of the followings: one or more frequency offsets; or one or more Doppler offsets,
wherein the frequency offset and/or the Doppler offset is at least on one of the followings: a service link; or a feeder link; and
the frequency offset and/or the Doppler offset is amount of offset experienced on the service link and/or on the feeder link, or the frequency offset and/or Doppler offset is amount of offset compensated by the base station on the service link and/or one the feeder link.

12. The UE of claim 11, wherein
the frequency offset and/or the Doppler offset on the service link comprises a frequency shift on a link between a satellite and the UE, and the link between the satellite and the UE comprises a link from the satellite to the UE and/or a link from the UE to the satellite, and
the frequency offset and/or the Doppler offset on the feeder link comprises a frequency shift on a link between a satellite and the base station, and the link between the satellite and the base station comprises a link from the satellite to the base station and/or a link from the base station to the satellite.

13. The UE of claim 10, wherein the second information is relevant to a satellite ephemeris data and/or a reference point status,
the satellite ephemeris data comprises at least one of the followings: one or more satellite positions; one or more satellite velocity; one or more reference times corresponding to the one or more satellites positions and/or the one or more satellite velocity, and
the reference point status comprises at least one of the followings: one or more reference point positions; one or more reference point velocity; one or more reference times corresponding to the one or more reference point positions and/or the one or more reference point velocity.

14. The UE of claim 10, wherein the first information and/or the second information are transmitted in at least one of the followings: a system information block (SIB); a radio resource control (RRC) message; a medium access control (MAC) control element (CE); or a downlink control information (DCI),
wherein the SIB comprises SIB x, wherein x is an integer larger than or equal to 1,
the RRC message comprises at least one of the followings: a cell-specific RRC message; or a UE-specific RRC message, and the RRC message comprises an RRC information element (IE) for an intra-frequency measurement and/or an inter-frequency measurement,
wherein the intra-frequency measurement and/or the inter-frequency measurement is based on a synchronization signal block (SSB) and/or a channel state information-reference signal (CSI-RS), and the RRC IE comprises MeasObjectNR.

15. The UE of claim 14, wherein the first information and/or the second information are associated with one or more cell indexes and/or one or more beam indexes and/or one or more frequencies,
wherein the one or more frequencies comprise at least one of the followings: SSB frequency; or reference frequency for the CSI-RS, and the one or more frequencies comprises a first point which is used for mapping of the CSI-RS to physical resources, wherein the SSB frequency is associated with the MeasObjectNR,
wherein the one or more beam indexes comprises at least one of the followings: an SSB index; a CSI-RS resource index; or a CSI-RS resource set index,
the one or more beam indexes are configured in the MeasObjectNR, and the one or more cell indexes are configured in the MeasObjectNR.

16. A base station, comprising:
a memory;
a transceiver; and
a processor coupled to the memory and the transceiver;
wherein the processor is configured to indicate to a user equipment (UE), a first information and/or a second information; and
wherein the processor is configured to configure the UE to use the first information and/or the second information for a downlink reception and/or an uplink transmission.

17. The base station of claim 16, wherein the first information and/or the second information is relevant to a frequency domain synchronization, and the frequency domain synchronization comprises at least one of the followings: one or more frequency offsets; or one or more Doppler offsets,
wherein the frequency offset and/or the Doppler offset is at least on one of the followings: a service link; or a feeder link, and
the frequency offset and/or the Doppler offset is amount of offset experienced on the service link and/or on the feeder link, or the frequency offset and/or Doppler offset is amount of offset compensated by the base station on the service link and/or on the feeder link.

18. The base station of claim 16, wherein the processor configuring the UE to use the first information and/or the second information for the downlink reception and/or the uplink transmission comprises:
the processor configuring the UE to compensate a first frequency offset or a first Doppler offset for the downlink reception and/or the UE to compensate the first frequency offset or the first Doppler offset for the uplink transmission.

19. The base station of claim 18, wherein the first Doppler offset is derived from at least one of the followings: a second Doppler offset; or a third Doppler offset,
the second Doppler offset is obtained from the first information, and the third Doppler offset is derived from the second information, and
the third Doppler offset is derived by the UE from a satellite ephemeris data and/or a reference point status, or the third Doppler offset is obtained from the first information.

20. The base station of claim 16, wherein the downlink reception comprises at least one of the followings: a physical downlink sharing channel (PDSCH) reception; a physical downlink control channel (PDCCH) reception, an SSB reception; or a CSI-RS reception, and
the uplink transmission comprises at least one of the followings: a physical uplink shared channel (PUSCH) transmission; a physical uplink control channel (PUCCH) transmission; a physical random access channel (PRACH) transmission; or a sounding reference signal (SRS) transmission.
